(19) United States
(12) Patent Application Publication
(10) Pub. No.: US 2011/0269328 A1
(43) Pub. Date: Nov. 3, 2011

(54) ELECTRICAL CARD CONNECTOR HAVING IMPROVED CARD RETAINING ELEMENTS

(75) Inventor: WEI-JIE HUO, Shenzhen (CN)

(73) Assignee: HON HAI PRECISION INDUSTRY CO., LTD., New Taipei (TW)

(21) Appl. No.: 13/097,075

(22) Filed: Apr. 29, 2011

(30) Foreign Application Priority Data
Apr. 29, 2010 (CN) 201020175069.5

(51) Int. Cl. H01R 13/62

(52) U.S. Cl. 439/345

(57) ABSTRACT

An electrical card connector (100) includes an insulating housing (1) defining a pair of channels (110), a number of terminals (2) received in the insulating housing (1), a metal shield (5) shielding over the insulating housing (1) for defining a card receiving space, and a pair of retaining elements (4) received in the corresponding channels (110). Each of the retaining elements (4) includes a metallic base member (40) having a contact portion (403) and an insulating member (42). The contact portion (403) laterally protrudes into the card received space. The insulating member (42) caps a corresponding contact portion (403).

### BACKGROUND OF THE INVENTION

1. Field of the Invention

The present invention relates generally to electrical card connectors, and more particularly to an electrical card connector having retaining elements for maintaining an inserted card in place and for preventing the retaining elements from scrapping the card.

2. Description of Related Arts

IC cards have been developed and a type of IC card called a subscriber identification module card (SIM card) is used in cellular phones as an identification and storage unit for subscriber related data. A SIM card connector is normally used for connection of the SIM card to the external equipment.

Chinese Patent No. CN201303072Y discloses an electrical card connector comprising an insulating housing, a shield shielding over the insulating housing, and a plurality of terminals received in the insulating housing. The insulating housing comprises a transversal wall and a pair of longitudinal walls integral with the transversal wall. Each longitudinal wall defines a receiving channel for receiving a corresponding retaining element. The two retaining elements provide retaining force between the inserted card and the electrical card connector so the card is prevented from shifting away from one side to the other side in the electrical card connector. For providing sufficient retaining force the retaining element is usually made by metal material, thus, scraping occurs between the card and the retaining elements.

Hence, an improved electrical card connector is desired.

### SUMMARY OF THE INVENTION

Accordingly, an object of the present invention is to provide an electrical card connector preventing the retaining elements from scrapping the card.

To achieve the above object, an electrical card connector includes an insulating housing defining a pair of channels, a plurality of terminals received in the insulating housing, a metal shield shielding over the insulating housing for defining a card receiving space, and a pair of retaining elements received in the corresponding channels. Each of the retaining elements forms includes a metallic base member having a contact portion and an insulating member. The contact portion laterally protrudes into the card received space. The insulating member caps a corresponding contact portion.

Other objects, advantages and novel features of the invention will become more apparent from the following detailed description when taken in conjunction with the accompanying drawings.

### BRIEF DESCRIPTION OF THE DRAWING

FIG. 1 is a perspective, partly assembled view of an electrical card connector according to the present invention; and

FIG. 2 is a perspective, exploded view of the electrical card connector.

### DETAILED DESCRIPTION OF THE PREFERRED EMBODIMENT

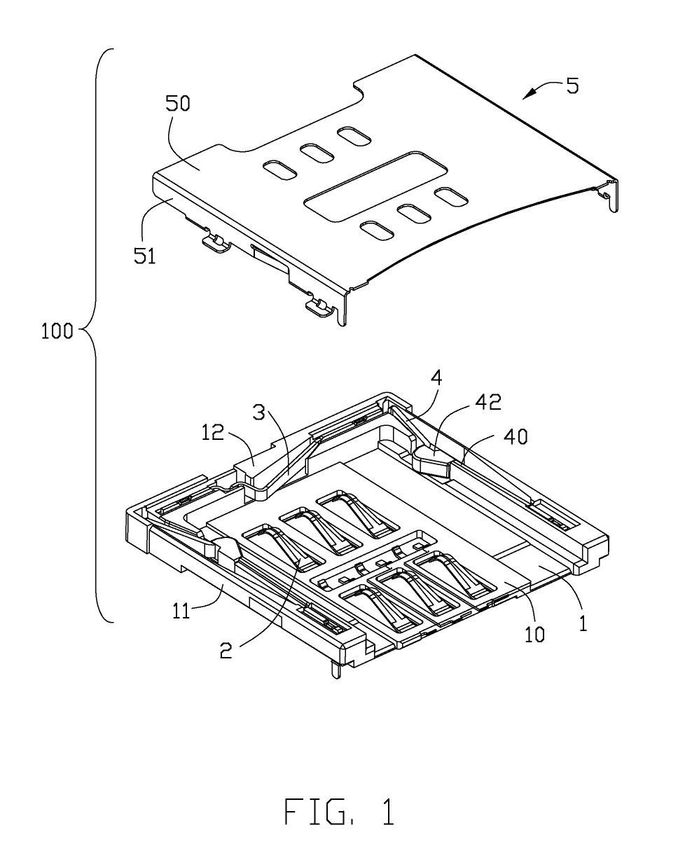

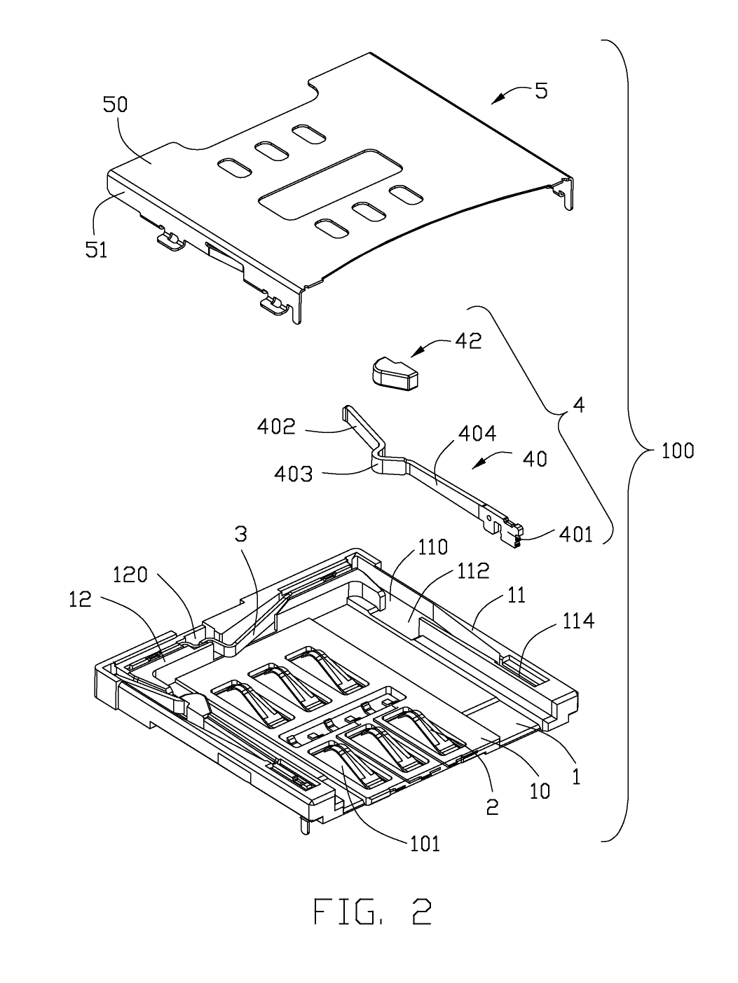

FIGS. 1-2 illustrate an electrical card connector 100 in accordance with the present invention. The electrical card connector 100 includes an insulating housing 1, a plurality of terminals 2, a switch element 3, a pair of retaining elements 4, and a metal shield 5 assembled on and shielding the insulating housing 1 for defining a card receiving space. The terminals 2, the switch element 3 and the retaining elements 4 are all received in the insulating housing 1.

The insulating housing 1 comprises a basic portion 10, a pair of longitudinal walls 11 extending upwardly from the two sides of the basic portion 10, and a transversal wall 12 integrated with the longitudinal walls 11. The basic portion 10 defines two rows of passageways 101 at an approximately middle part thereof for exposing the terminals 2. Each longitudinal wall 11 defines a channel (not labeled) for receiving the retaining element 4. The channel comprises a rear channel 110 proximal to the transversal wall 12, a cutout 112 opening to the card receiving space, and a front channel 114 distal from the transversal wall 12. The rear channel 110, the cutout 112, and the front channel 114 are communicated with each other. The cutout 112 is disposed between the rear channel 110 and the front channel 114 along the card insertion direction. The transversal wall 12 defines a slot 120 for operation of the switch element 3.

Each retaining element 4 received in the corresponding longitudinal wall 11 includes a metallic base member 40 and an insulating member or insulative cap 42 capping the base member 40. The base member 40 forms a main portion 404, a contact portion 403 curvedly extending from the main portion 404, a rear retaining portion 402 continuing the contact portion 403, and a front fixing portion 401 extending from the main portion 404. The fixing portion 401 is fixed in the second channel 114 and the retaining portion 402 is received in the first channel 110 so that the retaining element 4 is resiliently retained with the insulating housing 1. The contact portion 403 protrudes into the card receiving space through the cutout 112. The insulative cap 42 overmolds or is separately attached to the contact portion 403 and, therefore, the insulative cap 42 also protrudes into the card receiving space. The insulative cap 42 defines an ear-shaped configuration corresponding to the contact portion 403 and has a front portion adjacent to the main portion 404 and a rear portion adjacent to the retaining portion 402. The slope of the front portion is steeper than the rear portion, and the rear portion is slightly wider in lateral width than the front portion.

The metal shield 5 comprises a flat portion 50 and a pair of depending portions 51 and shields over the insulating housing 1. The metal shield 5 is assembled on the insulating housing 1 also for ESD purpose.

When a card is to be inserted into the card receiving space, the caps 42 instead of the contact portions 403 of the retaining elements 4 abut against two sides of the card. Then the retaining elements 4 provide the retaining force for the inserted card. Because the contact portions 403 are capped with the insulative caps 42, the card is prevented from being scrapped by the metallic base member 40.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical card connector comprising:
an insulating housing defining a pair of channels;
a plurality of terminals received in the insulating housing;
a metal shield shielding over the insulating housing for defining a card receiving space; and
a pair of retaining elements received in corresponding channels, each of the retaining elements including a metallic base member having a contact portion and an insulating member, the contact portion laterally protruding into the card receiving space, the insulating member capping the corresponding contact portion.

2. The electrical card connector as described in claim 1, wherein each of the insulating members is overmolded on the corresponding contact portion.

3. The electrical card connector as described in claim 1, wherein each of the insulating members is separately attached to the corresponding contact portion.

4. The electrical card connector as described in claim 1, wherein the metallic base member comprises a main portion from which the contact portion curvedly extends, a rear retaining portion continuing the contact portion, and a front fixing portion extending from the main portion, and the insulating housing defines a rear channel and a front channel respectively retaining the rear retaining portion and the front fixing portion.

5. The electrical card connector as described in claim 1, wherein the insulating member has a front portion and a rear portion slightly wider in lateral width than the front portion.

6. The electrical card connector as described in claim 1, wherein the insulating member has a rear portion and a front portion of which the slope is steeper than that of the rear portion.

7. The electrical card connector as described in claim 1, wherein the insulating member defines an ear-shaped configuration.

8. The electrical card connector as described in claim 1, further comprising a switch element retained at a rear of the insulating housing.

9. An electrical connector comprising:
an insulative housing defining a card receiving space with a contact area thereunder and a retention area beside;
a plurality of contacts disposed in the housing with contacting sections extending into the card receiving space;
at least one metallic spring retaining element assembled to the retention area with two opposite ends engaged with the housing and defining a contact portion between said two opposite ends and extending into the card receiving space; and
an insulative cap covering the contact portion.

10. The electrical connector as claimed in claim 9, wherein one of said two opposite ends is fixed to the housing while the other is simply supported by the housing.

11. The electrical connector as claimed in claim 9, further including another metallic spring retaining element with another cap on a corresponding contact portion to be assembled to the housing opposite to the metallic spring retaining element.
